(19) United States
(12) Patent Application Publication
(10) Pub. No.: US 2026/0269346 A1
(43) Pub. Date: Sep. 10, 2026

(54) ANODE FOR LITHIUM SECONDARY BATTERY AND METHOD FOR MANUFACTURING THE SAME

(71) Applicants: HYUNDAI MOTOR COMPANY, SEOUL (KR); KIA CORPORATION, SEOUL (KR); Kyungpook National University Industry-Academic Cooperation Foundation, Daegu (KR)

(72) Inventors: Ki Yoon Bae, Hwaseong-si (KR); Sang Heon Lee, Hwaseong-si (KR); Jong Chan Song, Hwaseong-si (KR); Sam Ick Son, Hwaseong-si (KR); Ji Young Kim, Hwaseong-si (KR); Ju Hyeon Lee, Daegu (KR); Ji Hoon Lee, Daegu (KR)

(73) Assignees: HYUNDAI MOTOR COMPANY, SEOUL (KR); KIA CORPORATION, SEOUL (KR); Kyungpook National University Industry-Academic Cooperation Foundation, Daegu (KR)

(21) Appl. No.: 19/333,205

(22) Filed: Sep. 18, 2025

(30) Foreign Application Priority Data
Mar. 10, 2025 (KR) 10-2025-0030869

(51) Int. Cl. H01M 10/48; H01M 4/04; H01M 4/133; H01M 4/1393; H01M 4/36; H01M 4/40; H01M 4/58; H01M 4/587; H01M 10/052

(52) U.S. Cl. CPC H01M 10/488; H01M 4/0404; H01M 4/133; H01M 4/1393; H01M 4/362; H01M 4/405; H01M 4/5825; H01M 4/587; H01M 10/052

(57) ABSTRACT

An anode for a lithium secondary battery includes a current collector, an anode active material layer disposed on the current collector, and a surface layer disposed on the anode active material layer. The anode can be characterized by using X-ray diffraction (XRD) analysis as having a ratio (I₂/I₁) of a peak intensity (I₂) of a second peak observed at a position having 2θ of 23.5±0.2°, to a peak intensity (I₁) of a first peak observed at a position having 2θ of 24±0.2°, of at least 0.21. The anode can be characterized by using X-ray Photoelectron Spectroscopy (XPS) analysis as having a ratio (I₄/I₃) of a peak intensity (I₄) of a fourth peak observed in a section ranging from 684.0 eV to 685.5 eV, to a peak intensity (I₃) of a third peak observed in a section ranging from 686.0 eV to 688.0 eV, of no more than 1.5.

### CROSS-REFERENCE TO RELATED APPLICATION

This application claims the benefit of priority to Korean Patent Application No. 10-2025-0030869, filed in the Korean Intellectual Property Office on Mar. 10, 2025, the entire contents of which are incorporated herein by reference.

### TECHNICAL FIELD

The present disclosure relates to an anode for a lithium secondary battery and a method for manufacturing the same, and some further aspects, relates to a pre-lithiated anode and a method for manufacturing the same.

### BACKGROUND

There is recent interest in reducing or restricting the use of fossil fuels in an effort to address environmental issues associated with emissions the fuels generate (e.g., carbon emissions such as carbon dioxide (CO₂)). The transportation industry has focused much attention toward alternative fuel vehicles, such as electric vehicles that employ e.g., a secondary battery. A typical lithium ion battery, allows for the movement of about 400 km through one charging, but challenges with the technology still exist (e.g., instability or risk of fire at a high temperature). In efforts to address these challenges, many companies have competitively developed technology around a next-generation secondary battery.

One example of a next generation lithium secondary battery includes an all solid state battery in which all components are made of solid material(s). Accordingly, the all solid state battery has a lower risk in fire or explosion and a higher mechanical strength, as compared to lithium ion battery technology that employs flammable organic solvent as an electrolyte. The general structure of an all solid state battery includes a cathode including a cathode active material layer bonded to a cathode current collector, an anode including an anode active material layer bonded to an anode current collector, and a solid electrolyte layer interposed between the cathode active material layer and the anode active material layer.

It is typical for the anode active material layer included in the all solid state battery to include a graphite-based anode active material. Nevertheless, an anode including the graphite-based material has a theoretic limitation in realizing and creating an all solid state battery having a higher energy density. Accordingly, metal materials, such as silicon, that are capable of forming an alloy with lithium have been investigated as a potential anode material. However, to date these new materials exhibit a lower energy density than predicted, likely due to lower initial efficiency as compared to a higher theoretical capacity.

It has also been shown that some lithium ions can react with an anode material (e.g., a graphite-based material, or a silicon-based material) to form a layer called a solid electrolyte interface (SEI), which plays an important role in stabilizing the performance of the battery and preventing side reactions between an electrolyte and an anode material. In this process of SEI layer formation, however, the lithium ion is consumed and is unavailable for use in subsequent charging/discharging cycles. This causes irreversible capacity loss in which the total capacity of the battery is reduced when at full charge.

In an effort to address the reduced capacity of such batteries, a pre-lithiation strategy was used to intercalate lithium into the anode, and thereby prevent a reduction in capacity. In particular, when a silicon-based active material having a high theoretical capacity (e.g., Si and/or SiO) is used as an anode active material, a pre-lithiation process is used in order to increase the initial coulomb efficiency. This strategy, however, degraded the life-span characteristics as the pre-lithiation formed a by-product layer on the cathode.

### SUMMARY

The present disclosure addresses the above-mentioned problems associated with the current state of the art, while also maintaining a number of advantages that have been previously achieved.

An aspect of the present disclosure provides an anode for a lithium secondary battery, capable of exhibiting an excellent initial capacity and/or an excellent initial efficiency, and/or that remains stably driven for long periods of time.

Another aspect of the present disclosure provides a method for manufacturing an anode for a lithium secondary battery according to the various aspects and embodiments described herein.

The technical problems addressed by the present disclosure are not limited to the specifically aforementioned problems, and any variety of other technical problems not specifically mentioned herein, but addressed by the disclosure, will be clearly understood by those skilled in the art from the following description.
(1) In an aspect, the present disclosure provides an anode for a lithium secondary battery, which includes a current collector, an anode active material layer disposed on the current collector, and a surface layer disposed on the anode active material layer. In embodiments, the anode can be characterized by X-ray diffraction (XRD) and comprises a peak intensity ratio (I₂/I₁) of at least 0.21, where (I₂) is a second peak intensity observed at a position having 2θ of 23.5±0.2°, and (I₁) is a first peak intensity observed at a position having 2θ of 24±0.2°. In some embodiments, X-ray Photoelectron Spectroscopy (XPS) analysis can be used to characterize the anode and comprises a peak intensity ratio (I₄/I₃) of a fourth peak intensity (I₄) observed in a range from 684.0 eV to 685.5 eV, to a third peak intensity (I₃) observed in a range from 686.0 eV to 688.0 eV, of no more than 1.5. In some embodiments, the anode comprises a peak intensity ratio (I₂/I₁) of at least 0.21 by XRD, and a peak intensity ratio (I₄/I₃) of no more than 1.5 by XPS.
(2) In some embodiments the present disclosure provides an anode for a lithium secondary battery, in which the I₁ value ranges from 4,000 a.u. to 6,000 a.u, in accordance with some of the aspects and embodiments described in (1).
(3) In some embodiments the present disclosure provides an anode for a lithium secondary battery, in which the I₂ value ranges from 1,000 a.u. to 1,500 a.u, in accordance with some of the aspects and embodiments described in (1) or (2).
(4) In some embodiments the present disclosure provides an anode for a lithium secondary battery, in which the I₃ value ranges from 10,000 a.u. to 13,000 a.u, in accordance with some of the aspects and embodiments described in any one of (1) to (3).
(5) In some embodiments the present disclosure provides an anode for a lithium secondary battery, in which the I₄ value ranges from 14,000 a.u. to 19,000 a.u., in accordance with some of the aspects and embodiments described in any one of (1) to (4).
(6) In some embodiments the present disclosure provides an anode for a lithium secondary battery, in which the anode for the lithium secondary battery has a color having a red color value (R) ranging from 115 to 125, a green color value (G) ranging from 115 to 125, and a blue color value (B) ranging from 90 to 100, when referenced to an RGB color chart, in accordance with some of the aspects and embodiments described in any one of (1) to (5).
(7) In some embodiments the present disclosure provides an anode for a lithium secondary battery, in which the surface layer has a thickness ranging from 10 nm to 100 nm, in accordance with some of the aspects and embodiments described in any one of (1) to (6).
(8) In some aspects and embodiments the disclosure provides a lithium secondary battery including the anode for the lithium secondary battery accordance with some of the aspects and embodiments described in any one of (1) to (7).
(9) In some aspects and embodiments the disclosure provides a method for manufacturing an anode for a lithium secondary battery, which includes forming an anode active material layer, comprising a carbon-based compound and a silicon-based compound, on a current collector (S1), applying an electrolyte solution, comprising a fluoride-based lithium salt, on a surface of the anode active material layer (S2), and bringing lithium metal into contact with the anode active material layer on the side comprising the applied electrolyte solution for a time ranging from 75 minutes to 150 minutes (S3).
(10) In some embodiments the method for manufacturing an anode for a lithium secondary battery, comprises contacting the lithium metal and anode active material layer in S3 under a pressure ranging from 0.2 kg/cm² to 1 kg/cm², in accordance with some of the aspects and embodiments described in (9).
(11) In some embodiments the method for manufacturing an anode for a lithium secondary battery, comprises contacting the lithium metal and anode active material layer in S3 for a time ranging from 90 minutes to 120 minutes, in accordance with some of the aspects and embodiments described in any one of (9) and (10).
(12) In some embodiments the method for manufacturing an anode for a lithium secondary battery, further comprises removing the lithium metal and the electrolyte solution after the contacting in ‘S3’ is performed (S4), in accordance with some of the aspects and embodiments described in any one of (9) to (11).

In an aspect the disclosure provides an anode for a lithium secondary battery, the anode comprising:
a current collector;
an anode active material layer disposed on the current collector; and
a surface layer disposed on the anode active material layer,
wherein by X-ray diffraction (XRD) analysis the anode comprises a characteristic ratio, (I₂/I₁), of a peak intensity (I₂) of a second peak, observed at a position having 2θ of 23.5±0.2°, to a peak intensity (I₁) of a first peak, observed at a position having 2θ of 24±0.2°, is at least 0.21, and
wherein by X-ray Photoelectron Spectroscopy (XPS) analysis the anode comprises a second characteristic ratio, (I₄/I₃), of a peak intensity (I₄) of a fourth peak, observed in a section ranging from 684.0 eV to 685.5 eV, to a peak intensity (I₃) of a third peak, observed in a section ranging from 686.0 eV to 688.0 eV, is 1.5 or less.

In embodiments of the above aspect and embodiments, the I₁ value ranges from 4,000 a.u. to 6,000 a.u.

In embodiments of the above aspect and embodiments, the I₂ value ranges from 1,000 a.u. to 1,500 a.u.

In embodiments of the above aspect and embodiments, the I₃ value ranges from 10,000 a.u. to 13,000 a.u.

In embodiments of the above aspect and embodiments, the I₄ value ranges from 14,000 a.u. to 19,000 a.u.

In some further embodiments of the above aspect and embodiments, the anode for the lithium secondary battery comprises a red color value (R) ranging from 115 to 125, a green color value (G) ranging from 115 to 125, and a blue color value (B) ranging from 90 to 100, when viewed with reference to an RGB color chart.

In embodiments of the above aspect and embodiments, the surface layer has a thickness ranging from 10 nm to 100 nm.

In embodiments of the above aspect and embodiments, the (XRD) does not have an observable peak at a position of 23.5±0.2°.

In embodiments of the above aspect and embodiments, the anode active material layer comprises at least one carbon-based compound and at least one silicon-based compound.

In embodiments of the above aspect and embodiments, the at least one carbon-based compound comprises graphite, mesocarbon microbeads (MCMB), highly oriented graphite (HOPG), amorphous carbon, hard carbon, and/or soft carbon, and the at least one silicon-based compound comprises a general formula of SiOₓ where 0≤x<2.

In embodiments of the above aspect and embodiments, the carbon-based compound comprises a lithiated LiC₆ phase, and the silicon-based compound comprises a lithiated Li₁₅Si₄ phase.

In embodiments of the above aspect and embodiments, the surface layer disposed on the anode active material layer comprises (i) a lithium fluoride-based compound of the general Formula LiₓF_{y}, and (ii) a lithium fluoride phosphate-based compound of the general formula LiₓPO_{y}F_{z}, wherein x, y, and z are each independently positive numbers.

In embodiments of the above aspect and embodiments, the surface layer disposed on the anode active material layer comprises (i) a lithium fluoride-based compound of the general Formula LiₓF_{y}, and (ii) a lithium fluoride phosphate-based compound of the general formula LiₓPO_{y}F_{z}, wherein x, y, and z are each independently positive numbers.

In another aspect, the disclosure provides a lithium secondary battery including the anode according to the above aspects and embodiments.

In yet another aspect, the disclosure provides a method for manufacturing an anode for a lithium secondary battery, the method comprising:
forming an anode active material layer comprising a carbon-based compound and a silicon-based compound, on a current collector (S1);
applying an electrolyte solution comprising a fluoride-based lithium salt to a surface of the anode active material layer (S2); and
bringing lithium metal into contact with the surface of the anode active material layer having the electrolyte solution for a time ranging from 75 minutes to 150 minutes (S3).

In embodiments of the method, the contact in S3 is performed under a pressure condition ranging from 0.2 kg/cm² to 1 kg/cm².

In embodiments of the method, the contact in S3 is performed for a time ranging from 90 minutes to 120 minutes.

In embodiments the method further comprises: removing the lithium metal and the electrolyte solution after the contact time is complete.

In embodiments of the method, the fluoride-based lithium salt in the electrolyte solution comprises LiPF₆ in a concentration ranging from 0.1 M to 2.0 M.

In yet another aspect, the disclosure provides an anode for a lithium secondary battery manufactured according to the method as described herein.

Other aspects and embodiments will be apparent to those of skill in the art in view of the description that follows.

### BRIEF DESCRIPTION OF THE DRAWINGS

The above and other objects, aspects, embodiments, features and advantages provided by the present disclosure will be more apparent in light of the following detailed description taken in conjunction with the accompanying drawings:

FIG. 1 schematically illustrates a method for manufacturing an anode for a lithium secondary battery according to an embodiment of the present disclosure;

FIG. 2 is a graph illustrating XRD analysis for an anode for a lithium secondary battery according to Embodiments 1 and 2 and Comparative examples 1 to 6 of the present disclosure;

FIG. 3 is a graph illustrating XRD analysis for an anode for a lithium secondary battery according to Comparative example 7 of the present disclosure;

FIG. 4 is a graph illustrating XRD analysis for an anode for a lithium secondary battery according to Comparative example 8 of the present disclosure;

FIGS. 5 and 6 are graphs illustrating XPS analysis for an anode for lithium secondary battery according to Embodiments 1 and 2 and Comparative examples 1 to 7 of the present disclosure;

FIG. 7 illustrates images captured according to Embodiment 1 and Comparative example 1 of the present disclosure;

FIG. 8 illustrates CS-SEM images obtained by capturing cross-sections in a charging/discharging process according to Embodiment 1 and Comparative example 1 of the present disclosure; and

FIGS. 9 and 10 are graphs illustrating charging/discharging at a 1^{st} cycle, a 5^{th} cycle and/or a 10^{th} cycle with respect to an anode for a lithium secondary battery according to Embodiments 1 and 2 and Comparative examples 1 to 6 of the present disclosure.

### DETAILED DESCRIPTION

Hereinafter, the present disclosure will be described in more detail for the understanding of the present disclosure. In this case, terms or words used in the present specification and the claims should not be interpreted as commonly-used dictionary meanings, but be interpreted as to be relevant to the technical scope of the present disclosure, particularly when the disclosure provides a definition or description of a term or a concept of the term(s) in order to explain the present disclosure and particular embodiments.

The terms used in the present disclosure are provided only for illustrative purposes, and the present disclosure is not limited thereto. The singular forms are intended to include the plural forms unless the context clearly indicates otherwise.

In this specification, it will be further understood that the terms “comprises,” “includes,” or “has,” specify the presence of stated features, numbers, steps, components, parts, or the combination thereof, but do not preclude the presence or addition of one or more other features, numbers, steps, components, and/or the combination thereof.

### Anode for Lithium Secondary Battery

In an aspect, the present disclosure provides an anode for a lithium secondary battery.

In general, when an all solid state battery is charged in the initial stage, some lithium ions react with an anode material (e.g., a graphite-based material, or a silicon-based materials) to form a layer called a solid electrolyte interface (SEI). However, in the SEI forming process, the lithium ion is consumed and cannot be reused in subsequent charging/discharging cycles, thereby causing irreversible capacity loss in which the total capacity of the battery is reduced after the initial charging stage.

While pre-lithiation technology has attempted to reduce the irreversible capacity loss, depending on employed schemes and conditions, it can generate a substantial by-product layer thereby reducing the lifespan of the anode in the lithium secondary battery.

As described herein, the inventors have developed technology that reduces initial stage irreversible capacity loss, while improving a lifespan characteristic, by modifying and adjusting the composition of the by-product layer formed on the anode through a pre-lithiation step.

According to an embodiment of the present disclosure, the anode for the lithium secondary battery comprises a current collector, an anode active material layer disposed on the current collector; and a surface layer disposed on the anode active material layer. In embodiments, the anode comprises a peak intensity ratio (I₂/I₁) of at least 0.21, by X-ray diffraction (XRD) analysis, wherein (I₂) is peak intensity of a second peak, observed when 2θ is at the position of 23.5±0.2°, and (I₁) is peak intensity of a first peak observed when 2θ is at a position of 24±0.2°. In some embodiments wherein the anode is analyzed by X-ray Photoelectron Spectroscopy (XPS), the anode comprises a peak intensity ratio (I₄/I₃) of no more than 1.5, wherein (I₄) is peak intensity of a fourth peak observed in a range from 684.0 eV to 685.5 eV, and (I₃) is peak intensity of a third peak observed in a range from 686.0 eV to 688.0 eV.

According to an embodiment of the present disclosure, the anode for the lithium secondary battery may have a color having a red color value (R) ranging from 115 to 125, a green color value (G) ranging from 115 to 125, and a blue color value (B) ranging from 90 to 100. Without being limited by theory, this characteristic may be due to several compounds that are formed in procedures for the method for manufacturing the anode, as described below.

The various components forming the anode for the lithium secondary battery according to embodiments of the present disclosure are described in detail below.

### Current Collector

According to an embodiment of the present disclosure, the current collector, which is an anode current collector, may be a base material having a plate form and having electrical conductivity. In some specific embodiments, the current collector may have the form of a sheet, a thin film, or a foil.

According to an embodiment, the current collector may include a material which does not react with lithium. In some specific embodiments, the anode current collector may include at least one of Ni, Cu, stainless steel (SUS), and/or any combinations thereof.

### Anode Active Material Layer

According to an embodiment of the present disclosure, the anode active material layer may be disposed on the current collector.

According to an embodiment of the present disclosure, the anode active material layer may include an anode active material, a solid electrolyte, and a binder.

According to an embodiment of the present disclosure, the anode active material may include a carbon-based compound and a silicon-based compound

According to some non-limiting embodiments of the present disclosure, the carbon active material may be graphite such as, for example, mesocarbon microbeads (MCMB) and/or highly oriented graphite (HOPG), or amorphous carbon such as, for example, hard carbon and/or soft carbon. In some embodiments, the silicon-based compound may be a compound having a formula of SiOₓ where 0≤x<2).

According to an embodiment of the present disclosure, the anode active material may have a structure wherein the silicon-based compound is disposed on a core that comprises the carbon-based compound. In such embodiments, an inner part of the core comprising the carbon-based compound may be porous. In some embodiments, the silicon-based compound may be disposed on an external surface of the core and on a surface of the inner porous structure, to form a coating layer that covers or substantially covers the external surface of the core and the inner porous structure. In some embodiments, the average diameter (D₅₀) of the core may range from 5 μm to 20 μm, and in some preferred embodiments may range from 8 μm to 15 μm. In some embodiments, the thickness of the coating layer may range from 10 nm to 50 nm, and in some preferred embodiments may range from 20 nm to 40 nm.

According to an embodiment of the present disclosure, when the anode active material comprises a structure having the core and the coating layer, the anode active material may be prepared by depositing a silicon-based compound in a gas phase on the graphite-based compound using known techniques such as, for example, a chemical vapor deposition scheme/method.

According to an embodiment of the present disclosure, the carbon-based compound and the silicon-based compound may be lithiated through a pre-lithiation method (e.g., step (S3) in accordance with the method for manufacturing the anode for the lithium secondary battery as described hereinbelow). Additional process conditions relating to the pre-lithiation methods will be described later.

In an embodiment, the carbon-based compound may be lithiated into a stage 1 (LiC₆) phase through a stage 2 (LiC₁₂) phase through the pre-lithiation step (e.g., described herein), and the silicon-based compound may be lithiated into a Li₁₅Si₄ phase through the pre-lithiation step. According to one embodiment of the present invention, the carbon-based compound may be completely lithiated into a Stage 1 (LiC₆) phase through the above-described pre-lithiation step. Accordingly, the peak corresponding to the (002) plane of Stage 2 (LiC₁₂) (observed at a position of about 23.5±0.2°) may not be detected.

In such pre-lithiation processes, since the silicon-based compound has electron conductivity lower than electron conductivity of the carbon-based compound, a lithiation rate of the carbon-based compound may be faster than a lithiation rate of the silicon-based compound. Accordingly, the phase transition of the silicon-based compound to the Li₁₅Si₄ phase may occur after the phase transition to Stage 1 of the carbon-based compound. Thus, when calculating the content ratio (Li₁₅Si₄/LiC₆) of the silicon-based compound to the content of Stage 1 phase of the carbon-based compound, it may be determined whether the pre-lithiation for the anode active material layer according to an embodiment of the present disclosure has been achieved.

According to an embodiment of the present disclosure, XRD analysis can be used to analyze the anode for the lithium secondary battery. In such embodiments, the XRD peak intensity (I₁) of a first peak observed at a position having 2θ of 24±0.2° is associated with the intensity of the peak related to Stage 1 phase (LiC₆), and is proportional to the content of stage 1 phase (LiC₆) present in the anode, while the XRD peak intensity (I₂) of a second peak observed at a position having 2θ of 23.5±0.2° is associated with the intensity of the peak related to the phase of Li₁₅Si₄, and is proportional to the content of the phase of Li₁₅Si₄ present in the anode.

According to an embodiment of the present disclosure, I₁ may range from 4,000 a.u. to 6,000 a.u. In some specific embodiments, I₁ may be at least 4,100 a.u., at least 4,200 a.u., at least 4,300 a.u., at least 4,400 a.u., or at least 4,500 a.u., and in some other embodiments, may be at most 5,900 a.u., at most 5,800 a.u., at most 5,700 a.u., at most 5,600 a.u., or at most 5,500 a.u. In embodiments falling within these ranges, the lithiation of the carbon-based compound may be completed or at least sufficiently performed.

According to an embodiment of the present disclosure, I₂ may range from 1,000 a.u. to 1,500 a.u. In some specific embodiments, I₂ may be at least 1,050 a.u., at least 1,100 a.u., at least 1,150 a.u., at least 1,200 a.u., or at least 1,250 a.u., and in some other embodiments, may be at most 1,450 a.u., at most 1,400 a.u., at most 1,350 a.u., or at most 1,300 a.u. In embodiments falling within these ranges, the lithiation of the silicon-based compound may be completed, or at least sufficiently performed.

According to an embodiment of the present disclosure, the I₂/I₁ may be at least 0.21. In some specific embodiments, the I₂/I₁ may be at least 0.212, at least 0.214, at least 0.216, at least 0.218, at least 0.220, at least 0.222, at least 0.224, at least 0.226, at least 0.228, or at least 0.230. In embodiments falling within this range, the lithiation of both the carbon-based compound and the silicon-based compound included in the anode active material may be completed, or at least sufficiently performed. When I₂/I₁ is less than the above range, the extent of lithiation of the silicon-based compound may not be completed or sufficiently performed (e.g., due to a smaller content of Li₁₅Si₄ phase), and which may result in a lower initial charging capacity and/or initial efficiency of the lithium secondary battery.

According to an embodiment of the present disclosure, the solid electrolyte may be an oxide-based solid electrolyte or a sulfide-based solid electrolyte. In some preferred embodiments, the sulfide-based solid electrolyte may comprise a high or relatively high lithium ion conductivity.

According to some non-limiting embodiments, the sulfide-based solid electrolyte may include at least one of Li₆PS₅X (where X=at least one of Cl, Br, and/or I), Li₁₀GeP₂Si₂, Li₃PS₄, Li₇P₃Sn₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where ‘m’ and ‘n’ are positive numbers; Z is one of Ge, Zn, and/or Ga), Li₂S—GeS₂, Li₂S—SiS₂—Li₃PO₄, Li₂S—SiS₂—LiₓMO_{y} (where ‘x’ and ‘y’ are positive numbers; M is one of P, Si, Ge, B, Al, Ga, and/or In), or any combinations thereof.

According to an embodiment of the present disclosure, the conductive material can be any component material that is sufficient to form an electron transferring path within the electrode. In some non-limiting embodiments, the conductive material may be a sp2 carbon material such as, for example, carbon black, conducting graphite, ethylene black, carbon nanotube, and/or graphene.

According to non-limiting embodiments of the present disclosure, the binder may include butadiene rubber (BR), nitrile butadiene rubber (NBR), hydrogenated nitrile butadiene rubber (HNBR), polyvinylidene difluoride (PVDF), polytetrafluoroethylene (PTFE), and/or carboxymethylcellulose (CMC).

### Surface Layer

According to an embodiment of the present disclosure, the surface layer may be disposed on the anode active material layer. In some embodiments, the surface layer may be formed through a pre-lithiation step (e.g., ‘S3’ in accordance with the method for manufacturing the anode for the lithium secondary battery described below), and may comprise a layer formed of a compound that is formed during the pre-lithiation step.

The surface layer according to an embodiment of the present disclosure may include a lithium fluoride-based compound and a lithium fluoride phosphate-based compound. The lithium fluoride-based compound and the lithium fluoride phosphate-based compound, which may be formed during a pre-lithiation step (e.g., ‘S3’ described herein) when manufacturing the anode for the lithium secondary battery (described below). The compounds may impart either or both of an excellent, or improved, mechanical property and a higher, or improved, ion conductivity to the surface layer (relative to embodiments that lack the surface layer). In non-limiting embodiments, the lithium fluoride-based compound may have the general formula LiₓF_{y}, (where X and Y are each independently a positive number) and the lithium fluoride phosphate-based compound may have the general formula LiₓPO_{y}F_{z}, (where X, Y and Z are each independently a positive number).

In some specific embodiments, the lithium fluoride-based compound may improve ion conductivity of the surface layer, and the lithium fluoride phosphate-based compound may improve the mechanical property of the surface layer. Notably, however, if the content of the lithium fluoride-based compound becomes excessive, the electron conductivity of the surface layer can be significantly reduced. This also can limit the charge transfer of the surface layer, thereby increasing battery internal resistance. Accordingly, embodiments of the disclosure provide an appropriate content ratio of the lithium fluoride-based compound to the lithium fluoride phosphate-based compound in the surface layer, and can be further adjusted as may be needed.

According to an embodiment of the present disclosure, when the XPS analysis is performed with respect to the anode for the lithium secondary battery, the peak intensity (I₃) of the third peak observed in a range from 686.0 eV to 688.0 eV is a peak intensity related to the lithium fluoride phosphate-based compound, and is proportional to the content of the lithium fluoride phosphate-based compound present in the anode. Similarly, the peak intensity (I₄) of the fourth peak observed in a range from 684.0 eV to 685.5 eV is a peak intensity related to the lithium fluoride-based compound, and is proportional to the content of the lithium fluoride-based compound present in the anode.

According to an embodiment of the present disclosure, the I₃ may range from 10,000 a.u. to 13,000 a.u. In some specific embodiments, the I₃ may be at least 10,100 a.u., at least 10,200 a.u., at least 10,300 a.u., at least 10,400 a.u., or at least 10,500 a.u., and in some other embodiments, at most 12,900 a.u., at most 12,800 a.u., at most 12,700 a.u., at most 12,600 a.u., or at most 12,500 a.u. In embodiments within these ranges, the lithium fluoride phosphate-based compound may be determined as being present in an appropriate amount.

According to an embodiment of the present disclosure, the I₄ may range from 14,000 a.u. to 19,000 a.u. In some specific embodiments, the I₄ may be at least 14,100 a.u., at least 14,200 a.u., at least 14,300 a.u., at least 14,400 a.u., or at least 14,500 a.u., and in some other embodiments, at most 18,500 a.u., at most 18,000 a.u., at most 17,500 a.u., at most 17,000 a.u., or at most 16,000 a.u. In embodiments within these ranges, the lithium fluoride-based compound may be determined as being present in an appropriate amount.

According to an embodiment of the present disclosure, the I₄/I₃ may be at most 1.5. In some specific embodiments, the I₄/I₃ may be at least 1.0, at least 1.02, at least 1.04, at least 1.06, at least 1.08 or at least 1.1, and in some other embodiments, at most 1.48, at most 1.46, at most 1.44, at most 1.42, or at most 1.4. In embodiments within these ranges, the ratio of the lithium fluoride-based compound to the lithium fluoride phosphate-based compound is in accordance with the present disclosure. In such embodiments, the mechanical property of the surface layer may be improved, and appropriate electrical conductivity and ion conductivity may be expressed, thereby improving a battery lifespan characteristic. In contrast, when the I₄/I₃ is less than the range described above, the content of the lithium fluoride-based compound is excessively reduced, such that the ion conductivity of the surface layer is degraded. Also in contrast, when the I₄/I₃ exceeds the range described above, the content of the lithium fluoride-based compound is excessively increased, such that the electrical conductivity of the surface layer is degraded, thereby degrading a battery lifespan characteristic.

According to an embodiment of the present disclosure, the surface layer may have a thickness ranging from 10 nm to 100 nm. In some specific embodiments, the thickness of the surface layer may be at least 15 nm, at least 20 nm, at least 25 nm, at least 30 nm, or at least 35 nm, and in some other embodiments, at most 90 nm, at most 80 nm, at most 70 nm, at most 60 nm, or at most 50 nm. In embodiments within these ranges, the mechanical property of the anode for the lithium secondary battery may be improved.

### Method for Manufacturing Anode for Lithium Secondary Battery

In an aspect, the present disclosure provides a method for manufacturing an anode for a lithium secondary battery.

According to an embodiment of the present disclosure, the method for manufacturing the anode for the lithium secondary battery comprises forming an anode active material layer, which includes the carbon-based compound and the silicon-based compound, each in accordance with the disclosure, on the current collector (S1); applying an electrolyte solution containing a phosphorus fluoride lithium salt to a surface of the anode active material layer (S2); and bringing lithium metal into contact with the surface of the anode active material layer having the applied electrolyte solution for a time ranging from 75 minutes to 150 minutes (S3).

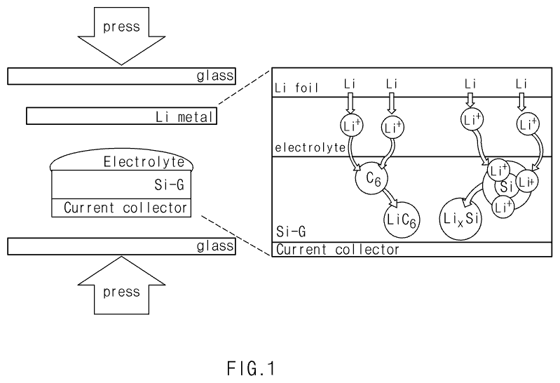

FIG. 1 schematically illustrates a method for manufacturing an anode for a lithium secondary battery according to an embodiment of the present disclosure. Hereinafter, the method for manufacturing the anode for the lithium secondary battery will be described in a series of operations or steps with reference to FIG. 1.

### ‘S1’

According to an embodiment of the present disclosure, the method for manufacturing the anode for the lithium secondary battery may include forming the anode active material layer, comprising the carbon-based compound and the silicon-based compound, on the current collector (S1).

According to an embodiment of the present disclosure, ‘S1’ may be performed using chemical vapor deposition methods by introducing one or more carbon-based compound powders and one or more silicon-based compound source gases into a reactor under conditions adequate to prepare powders having a structure comprising a core including the carbon-based compound and the silicon-based compound coated on the core, introducing the prepared powders into an N-methyl-2-pyrrolidone (NMP) solvent to prepare a slurry, and applying the slurry onto the prepared current collector.

### ‘S2’

According to an embodiment of the present disclosure, the method for manufacturing the anode for the lithium secondary battery may include applying the electrolyte solution containing the phosphorus fluoride lithium salt to at least one surface of the anode active material layer (S2).

According to an embodiment of the present disclosure, the electrolyte solution may include a material having high lithium ion conductivity, and may include a lithium salt and an organic solvent. In some embodiments, the lithium salt comprises a phosphorus fluoride lithium salt such as, for example, LiPF₆.

According to an embodiment of the present disclosure, the concentration of the phosphorus fluoride lithium salt may range from 0.1 M to 2.0 M. In embodiments comprising the above concentration range, the electrolyte solution typically has an appropriate conductivity and an appropriate viscosity. Accordingly, such embodiments can exhibit excellent electrolyte performance and effective movement of the lithium ion.

The organic solvent used in the method is not particularly limited. According to an embodiment, the organic solvent can be any such solvent as long as it can serve as a medium that allows for the movement of ions involved in an electrochemical reaction of a battery. In some non-limiting examples, the organic solvent may include any of an ester-based solvent, an ether-based solvent, a ketone-based solvent, an aromatic hydrocarbon-based solvent, a carbonate-based solvent, an alcohol-based solvent, a nitrile-based solvent, an amide-based solvent, a dioxalane-based solvent, a sulfolane-based solvent, and/or combinations thereof.

In some further embodiments, the organic solvent may include an ester-based solvent, including the non-limiting examples of methyl acetate, ethyl acetate, γ-butyrolactone, and ε-caprolactone; an ether-based solvent, including the non-limiting examples of dibutyl ether or tetrahydrofuran, a ketone-based solvent, including the non-limiting example of cyclohexanone, an aromatic hydrocarbon-based solvent including the non-limiting examples of benzene or fluorobenzene, a carbonate-based solvent, including the non-limiting examples of dimethylcarbonate (DMC), diethylcarbonate (DEC), methylethylcarbonate (MEC), ethylmethylcarbonate (EMC), ethylene carbonate (EC), or propylene carbonate (PC), an alcohol-based solvent, including the non-limiting examples of ethyl alcohol or isopropyl alcohol, nitriles including the non-limiting examples of R—CN (where R is a linear-chain, branched, or cyclic hydrocarbon group having 2 to 20 carbon atoms, and may include a double bond direction ring or an ether bond), amides including the non-limiting example of dimethylformamide, dioxolane including the non-limiting examples of such as 1,3-dioxolans, and sulfolanes.

According to another embodiment of the present disclosure, the organic solvent may be a carbonate-based solvent. In some preferred embodiments, the organic solvent may comprise a mixture of a cyclic carbonate (for example, ethylene carbonate or propylene carbonate) having high ion conductivity and high dielectric constant, which can improving charging and discharging performance of a battery, and a linear carbonate-based compound having low viscosity (for example, ethyl methyl carbonate, dimethyl carbonate, or diethyl carbonate). In such embodiments, the performance of the electrolyte solution can be improved, for example, when the cyclic carbonate and the linear carbonate are mixed at a volume ratio ranging from about 1:1 to about 1:9.

### ‘S3’

According to an embodiment of the present disclosure, the method for manufacturing the anode for the lithium secondary battery may include bringing lithium metal into contact with the anode active material layer on a surface with an applied electrolyte solution for the time ranging from 75 minutes to 150 minutes (S3).

According to an embodiment of the present disclosure, after the electrolyte solution is applied on the anode active material layer, lithium metal that serves as a lithium source may be stacked to form a pressed structure. The lithium metal, which provides lithium ions to the anode active material layer in the pre-lithiation step (described hereinbelow), may include, in some embodiments, a lithium (Li) foil. In such embodiments, the area of the lithium metal may be larger than an area of the anode active material layer.

Following the contacting, the surface layer may be formed on the anode active material layer by applying pressure to the pressed structure in a stack direction. According to an embodiment of the present disclosure, the pressure applied to the pressed structure may range from 0.2 kg/cm² to 1 kg/cm². Thus, the contacting in ‘S3’ may be performed under a pressure ranging from 0.2 kg/cm² to 1 kg/cm². In some embodiments, the pressure may be at least 0.25 kg/cm², at least 0.3 kg/cm², at least 0.35 kg/cm², at least 0.4 kg/cm², or at least 0.45 kg/cm², and in some other embodiments, at most 0.9 kg/cm², at most 0.8 kg/cm², at most 0.7 kg/cm², at most 0.6 kg/cm², or at most 0.5 kg/cm². Pressure conditions within these ranges allows the pre-lithiation step to be smoothly performed in accordance with the disclosure.

According to an embodiment of the present disclosure, the contact in ‘S3’ may be performed for the time ranging from 75 minutes to 150 minutes. In some embodiments, the time may be at least 80 minutes, at least 82 minutes, at least 84 minutes, at least 86 minutes, at least 88 minutes, or at least 90 minutes, and in some other embodiments, at most 145 minutes, at most 140 minutes, at most 135 minutes, at most 130 minutes, at most 125 minutes, or at most 120 minutes. Within these time ranges, the resulting process typically provides for the XRD peak intensity ratio and the XPS peak intensity ratio in accordance with the disclosure. In contrast, when the contact time is less than the range described above, the lithiation of the carbon-based compound or the silicon-based compound in the anode active material is typically insufficiently performed. The insufficient conditions, which result in low content of the lithium fluoride-based compound in the surface layer may lower the initial charging capacity and/or the initial efficiency of the lithium secondary battery. Also in contrast, when the contact time in ‘S3’ exceeds the above range, the excessive content of lithium fluoride-based compound in the surface layer may lower the electrical conductivity of the surface layer, thereby degrading the battery lifespan characteristic.

According to an embodiment of the present disclosure, the method for manufacturing the anode for the lithium secondary battery may further include removing the lithium metal and the electrolyte solution (S4) following the ‘S3’ process.

### All Solid State Battery

The present disclosure provides an all solid state battery including the anode for the lithium secondary battery in accordance with the various aspects and embodiments of the disclosure.

According to an embodiment of the present disclosure, the all solid state battery may have a stack structure comprising an anode, a solid electrolyte layer, a cathode active material layer, and a cathode current collector. The anode in these aspects and embodiments relating to the lithium secondary battery are in accordance with the anode described above and will not be repeated in the following description.

According to an embodiment of the present disclosure, the solid electrolyte layer, which functions to transfer a lithium ion between the cathode and the anode, may include any solid electrolyte having lithium ion conductivity. In some embodiments, the solid electrolyte includes at least one of an oxide-based solid electrolyte, a sulfide-based solid electrolyte, a polymer electrolyte, and a combination thereof. In some preferred embodiments, the solid electrolyte comprises a sulfide-based solid electrolyte.

According to an embodiment of the present disclosure, the sulfide-based solid electrolyte may include at least one of Li₆PS₅X (X=at least one selected from the group consisting of Cl, Br, and/or I), Li₁₀GeP₂S₁₂, Li₃PS₄, Li₇P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where ‘m’ and ‘n’ are positive numbers; Z is one of Ge, Zn, and/or Ga), Li₂S—GeS₂, Li₂S—SiS₂—Li₃PO₄, Li₂S—SiS₂—LiₓMO_{y} (where ‘x’ and ‘y’ are positive numbers; M is one of P, Si, Ge, B, Al, Ga, and/or In), and a combination thereof.

According to an embodiment of the present disclosure, the cathode active material layer may include a cathode active material, as well as the solid electrolyte, the conductive material, and the binder as discussed herein.

According to an embodiment of the present disclosure, the cathode active material is not particularly limited and can include, for example, an oxide active material and/or a sulfide active material.

According to an embodiment of the present disclosure, the oxide active material may include a rock salt type active material, such as, for example, LiCoO₂, LiMnO₂, LiNiO₂, LiVO₂, or Li₁₊ₓNi_{1/3}Co_{1/3}Mn_{1/3}O₂, a spinel type active material, such as, for example, LiMn₂O₄, or Li(Ni_{0.5}Mn_{1.5})O₄, reverse spinel type active material, such as, for example, LiNiVO₄, or LiCoVO₄, an olivine-type active material, such as, for example, LiFePO₄, LiMnPO₄, LiCoPO₄, or LiNiPO₄, a silicon-containing active material, such as, for example, Li₂FeSiO₄, or Li₂MnSiO₄, or in some further embodiments, a rock salt type active material, such as, for example, LiNi_{0.8}Co_{(0.2-x)}AlₓO₂(where 0<x<0.2), and which can be obtained by substituting a portion of transition metal with a heterogeneous metal; a spinel-type active material, such as, for example, Li₁₊ₓMn_{2-x-y}M_{y}O₄ (where M is at least one of Al, Mg, Co, Fe, Ni, and/or Zn; 0<x+y<2), and which can be obtained by substituting a portion of the transition metal with a heterogeneous metal; or lithium titanate such as, for example, Li₄Ti₅O₁₂.

According to an embodiment of the present disclosure, the sulfide active material may be copper chevrel, iron sulfide, cobalt sulfide, and/or nickel sulfide.

According to an embodiment of the present disclosure, the solid electrolyte may be an oxide-based solid electrolyte or a sulfide-based solid electrolyte. In some preferred embodiments, the solid electrolyte may include the sulfide-based solid electrolyte having a higher lithium ion conductivity.

The conductive material and the binder have been described above in relation to other aspects and embodiments, and the details thereof will be omitted from the following description.

According to an embodiment of the present disclosure, the cathode current collector may comprise a base material having a plate form and having electrical conductivity. In some specific embodiments, the cathode current collector may have the form of a sheet, or a thin film.

According to an embodiment of the present disclosure, the cathode current collector may include at least one of indium, copper, magnesium, aluminum, stainless steel, iron, and/or any combination thereof

According to an embodiment of the present disclosure, the solid electrolyte can comprise a free-standing film that is positioned between the anode active material layer and the cathode active material layer in a configuration sufficient to transfer a lithium ion.

Hereinafter, the present disclosure will be described in more detail through the following examples and experimental descriptions, which serve only to illustrate aspects and embodiments of the present disclosure in more detail. It will be understood that the scope of the present disclosure is not limited by the following examples and experimental descriptions.

### Example 1

### <Preparing for Anode Active Material Layer>

Graphite powders and SiH₄ gas were introduced into a reactor to perform a chemical vapor deposition (CVD) reaction process such that Si-G powders are obtained.

The Si-G powders obtained above and polyacrylic acid (PAA) were introduced into an N-methyl-2-pyrrolidone (NMP) solvent in a ratio of 95 to 5 (Si-G to PAA) by weight to prepare a slurry. The slurry was applied on a Ni-coated Cu thin film, which serves as an anode current collector, and vacuum-dried (50° C. oven) for 24 hours. Then, an electrode punched with 12.9 Φ was weighed (loading per area=2.2 mg/cm²) using a precision balance to prepare an anode having an anode active material layer.

### <Pre-Lithiation Process>

200 μL of an electrolyte having a concentration of 1.15M and a composition of LiPF₆ in EC/EMC (v/v=3:7) with 5 wt % FEC was coated on a surface of the anode active material layer prepared above. A lithium (Li) foil (3 cm×4 cm; thickness of 500 μm) larger than the diameter of the anode was disposed on the electrolyte-coated surface on the cathode active material layer to cover the entire portion of the anode active material layer.

Subsequently, a pressing structure including the anode, the electrolyte solution, and the lithium source was placed on a glass plate (lower glass plate), and another glass plate (upper glass plate) serving as a pressing plate was stacked on the top surface of the pressing structure. Thereafter, the lower and upper glass plates were pressed under a pressure ranging from 0.2 kg/cm² to 1 kg/cm² for 120 minutes to perform the pre-lithiation process, and forming a surface layer on the anode active material layer.

Thereafter, the pressure applied to the pressing structure was released, the anode was collected, and the collected anode was washed with a dimethyl carbonate solvent and dried under a room temperature vacuum for 1 hour to remove the solvent, such that an anode for a lithium secondary battery is manufactured.

### Example 2

For this example the anode for the lithium secondary battery was manufactured in the same manner as in Example 1, except that the lower and upper glass plates were pressed for 90 minutes in the pre-lithiation process.

### Comparative Example 1

Graphite powders and SiH₄ gas were introduced into a reactor to perform a chemical vapor deposition (CVD) reaction such that Si-G powders were obtained.

The Si-G powders obtained above and polyacrylic acid were introduced into an N-methyl-2-pyrrolidone (NMP) solvent in a ratio of 95 to 5 (Si-G to PAA) by weight to prepare a slurry. The slurry was applied on a Ni-coated Cu thin film, which serves as an anode current collector, and vacuum-dried (50° C. oven) for 24 hours. Then, an electrode punched with 12.9 Φ was weighed (loading per loading=2.2 mg/cm²) using a precision balance to prepare an anode for the lithium secondary battery having an anode active material layer.

### Comparative Example 2

For this example, the anode for the lithium secondary battery was manufactured in the same manner as in Example 1, except that the lower and upper glass plates were pressed for 30 minutes in the pre-lithiation process.

### Comparative Example 3

For this example, the anode for the lithium secondary battery was manufactured in the same manner as in Example 1, except that the lower and upper glass plates were pressed for 60 minutes in the pre-lithiation process.

### Comparative Example 4

For this example, the anode for the lithium secondary battery was manufactured in the same manner as in Example 1, except that the lower and upper glass plates were pressed for 180 minutes in the pre-lithiation process.

### Comparative Example 5

For this example, the anode for the lithium secondary battery was manufactured in the same manner as in Example 1, except that the lower and upper glass plates were pressed for 300 minutes in the pre-lithiation process.

### Comparative Example 6

### <Preparing Anode Active Material Layer>

Graphite powders and SiH₄ gas were introduced into a reactor to perform a chemical vapor deposition (CVD) reaction such that Si-G powders were obtained.

The Si-G powders obtained above and polyacrylic acid were introduced into an N-methyl-2-pyrrolidone (NMP) solvent in a ratio of 95 to 5 (Si-G to PAA) by weight to prepare a slurry. The slurry was applied on a Ni-coated Cu thin film as an anode current collector, and vacuum-dried (50° C. oven) for 24 hours, and an electrode punched with 12.9 Φ was weighed (loading per loading=2.2 mg/cm²) using a precision balance to prepare an anode having an anode active material layer.

### <Pre-Lithiation Process>

A lithium (Li) foil (3 cm×4 cm; thickness of 500 μm), serving as a lithium source and having a diameter larger than the diameter of the anode, was disposed on the anode active material layer prepared above to cover the entire portion of the anode active material layer.

Subsequently, a pressing structure including the anode, and the lithium source was placed on a glass plate (lower glass plate), and another glass plate (upper glass plate) serving as a pressing plate was stacked on the top surface of the pressing structure. Thereafter, the lower and upper glass plates were pressed under the pressure ranging from 0.2 kg/cm² to 1 kg/cm² for 300 minutes to perform the pre-lithiation process, thereby forming a surface layer on the anode active material layer.

Thereafter, the pressure applied to the pressing structure was released, the anode was collected, and the collected anode was washed with a dimethyl carbonate solvent and dried under a room temperature vacuum for 1 hour to remove the solvent, such that an anode for a lithium secondary battery is manufactured.

### Comparative Example 7

### <Manufacturing Anode Active Material Layer>

Graphite powders and SiH₄ gas were introduced into a reactor to perform a chemical vapor deposition (CVD) reaction such that Si-G powders were obtained.

The Si-G powders obtained above and polyacrylic acid were introduced into an N-methyl-2-pyrrolidone (NMP) solvent in a ratio of 95 to 5 (Si-G to PAA) by weight to prepare a slurry. The slurry was applied on a Ni-coated Cu thin film as an anode current collector, and vacuum-dried (50° C. oven) for 24 hours, and an electrode punched with 12.9 Φ was weighed (loading=2.2 mg/cm²) using a precision balance to prepare an anode having an anode active material layer.

### <Pre-Lithiation Process>

A half-cell of a coin cell was formed using an electrolyte having 1.15M of LiPF₆ in EC/EMC (v/v=3:7) with 5 wt % FEC, an Si-G electrode punched with 12.9 Φ, and lithium metal, and lithiation was performed to 0.01V at the current density of 150 mA/g in a relevant system.

### Comparative Example 8

### <Manufacturing Anode Active Material Layer>

Graphite powders and SiH₄ gas were introduced into a reactor to perform a chemical vapor deposition (CVD) reaction such that Si-G powders were obtained.

The Si-G powders obtained above and polyacrylic acid were introduced into an N-methyl-2-pyrrolidone (NMP) solvent in a ratio of 95 to 5 (Si-G to PAA) by weight to prepare a slurry. The slurry was applied on a Cu-coated Ni thin film as an anode current collector, vacuum-dried (50° C. oven) for 24 hours, and an electrode punched with 12.9 Φ was weighed (loading=2.2 mg/cm²) using a precision balance to prepare an anode having an anode active material layer.

### <Pre-Lithiation Process>

A half-cell of a coin cell was formed using an electrolyte having 1.15 M of LiPF₆ in EC/EMC (v/v=3:7) with 5 wt % FEC, an Si-G electrode punched with 12.9 Φ, and lithium metal, and lithiation was performed while maintaining the constant voltage of 0 V for 210 minutes, thereby performing lithiation in the relevant system.

### Experimental Example 1—XRD Analysis

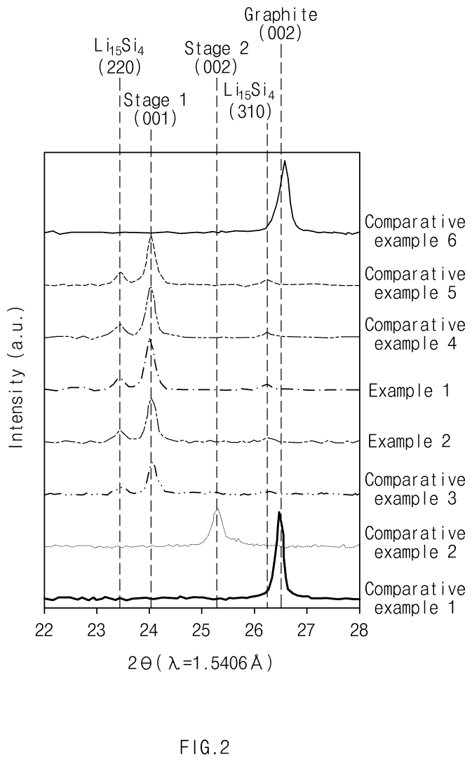

X-ray diffraction (XRD) analysis was performed with respect to each of anodes manufactured in Examples 1 and 2 and Comparative examples 1 to 6 with a voltage of 40 kV, a current of 30 mA, CuKα radiation, and 2θ (brag angle)=22° to 28°, and scan speed=0.01°/100 sec using Xpert-Pro (by PANalytical). The result of the XRD analysis is shown in FIG. 2, and the intensity of each peak observed is shown in Table 1.

TABLE 1

| | | Stage 1; | Stage 2; | | | |
|---|---|---|---|---|---|---|
| | Li₁₅Si₄ | LiC₆ | LiC₁₂ | Li₁₅Si₄ | graphite | |
| | (220) | (001) | (002) | (310) | (002) | I₂/I₁ |
| Example 1 | 1149.0 | 4855.3 | — | 408.7 | — | 0.237 |
| Example 2 | 1257.4 | 5741.2 | — | 496.6 | — | 0.219 |
| Comparative | — | — | — | — | 9033.9 | — |
| example 1 | | | | | | |
| Comparative | — | — | 3954.8 | — | — | — |
| example 2 | | | | | | |
| Comparative | 763.2 | 3696.3 | 160.4 | 252.2 | — | 0.206 |
| example 3 | | | | | | |
| Comparative | 1278.9 | 5518.8 | — | 496.8 | — | 0.232 |
| example 4 | | | | | | |
| Comparative | 1355.2 | 5544.7 | — | 473.1 | — | 0.244 |
| example 5 | | | | | | |
| Comparative | — | — | — | — | 7476.9 | — |
| example 6 | | | | | | |

Referring to FIG. 2, a peak observed at a position having 2θ of 23.5±0.2° (the first peak) relates to a (220) plane of Li₁₅Si₄, a peak observed at a position having 2θ of 24±0.2° (the second peak) relates to a (001) plane of Stage 1(LiC₆), a peak observed at a position having 2θ of 23.5±0.2° is a peak related to a (002) plane of Stage 2 (LiCl₂), a peak observed at a position having 2θ of 26.1±0.2° is a peak related to a (310) plane of Li₁₅Si₄, and a peak observed at a position having 2θ of 26.5±0.2° is a peak related to a (002) plane of graphite.

The data shows the anode active material layer used for the anode according to Examples 1 and 2, and Comparative examples 1 to 6 may include a carbon-based compound and a silicon-based compound. The carbon-based compound is lithiated through the pre-lithiation process and then is lithiated into a stage 1 (LiC₆) phase through a stage 2 (LiCi₂) phase. Then, the silicon-based compound is lithiated to a Li₁₅Si₄ phase through the pre-lithiation process. Further, a remaining peak (except for a peak related to a (002) plane of graphite) was not observed in the anode according to Comparative example 1 without the pre-lithiation process. Referring to Examples 1 and 2, and Comparative examples 2 to 5, it may be recognized that the intensity (I₁) of a peak (first peak) related to the (220) plane of Li₁₅Si₄ is increased as the time to perform the pre-lithiation process is increased.

In addition, in the pre-lithiation, since the silicon-based compound has electron conductivity lower than the electron conductivity of the carbon-based compound, a lithiation rate of the carbon-based compound may be faster than a lithiation rate of the silicon-based compound. Accordingly, the phase transition of the silicon-based compound to the Li₁₅Si₄ phase may be made after the phase transition of the carbon-based compound to Stage 1 phase. When the ratio (I₂/I₁) of the intensity (I₂) of the peak (second peak) related to the (001) plane of the stage 1 (LiC₆) phase to the intensity (I₁) of the peak (first peak) related to the (220) plane of Li₁₅Si₄ is calculated based on the above information, it may be determined whether lithiation of the carbon-based compound and lithiation of the silicon-based compound were properly performed through pre-lithiation.

Accordingly, data indicates that the ratio of the intensity of the peak (second peak) which is related to the (001) plane of the stage 1 (LiC₆) phase, to the intensity of the peak (first peak) which is related to the (220) plane of the Li₁₅Si₄ according to Comparative Examples 2 and 3—each with a lower pre-lithiation time—does not exceed 0.21, among all the ratios measured for Examples 1 and 2 and Comparative examples 2 and 5. Accordingly, the data appears to show that the lithiation of the carbon-based compound and the lithiation of the silicon-based compound present in the anode active material of those Examples are not sufficient to generate the anodes in accordance with the disclosure. In particular, according to Comparative examples 2 and 3, it may be that phases (stage 1 and stage 2) were mixed, as the lithiation of the carbon-based compound is not completely performed.

Meanwhile, the data for Comparative example 6 in which the pre-lithiation step is performed by bringing the lithium source into contact with the anode active material layer without the electrolyte solution, appears to show that the pre-lithiation step is not performed successfully (i.e., in accordance with the embodiments of the disclosure), as there is no other remaining peak observed, except for the peak related to the (002) plane of graphite.

### Experimental Example 2—XRD Analysis

While the pre-lithiation process was performed according to each of Comparative examples 7 and 8, X-ray diffraction analysis was performed with respect to the anode being under pre-lithiation using Xpert-Pro (by PANalytical) depending on progress times, under the conditions of a voltage of 40 kV, a current of 30 mA, CuKα radiation, 2θ (Bragg angle) ranging from 12° to 18°, and a scan speed of 0.01°/100 sec.

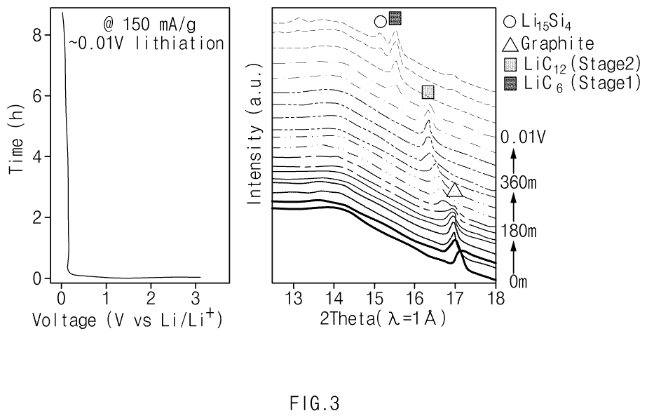

Referring to FIG. 3, it may be recognized that a Li₁₅Si₄ phase, which was obtained by lithiating the silicon-based compound, was observed after the pre-lithiation was performed for eight hours. Accordingly, the data appears to show that the pre-lithiation reaction (Comparative example 7) speed based on electrochemical lithiation was significantly slow, relative to the pre-lithiation manner according to an example in accordance with the embodiments of the disclosure.

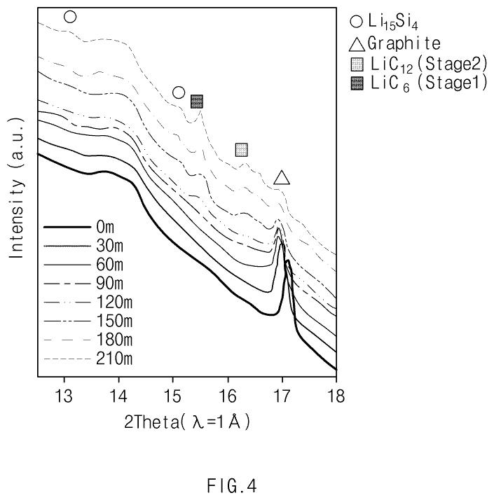

In addition, referring to FIG. 4, the data appears to show that the silicon-based compound was lithiated, and the graphite-based compound was not uniformly lithiated, even when the pre-lithiation time of 210 minutes had elapsed, so phases (Stage 1 and Stage 2) were mixed, in the pre-lithiation reaction (Comparative example 8) based on observed Electrochemical short.

### Experimental Example 3—XPS Analysis

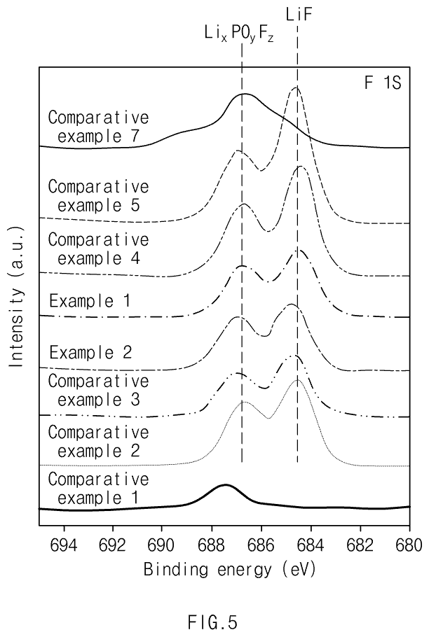

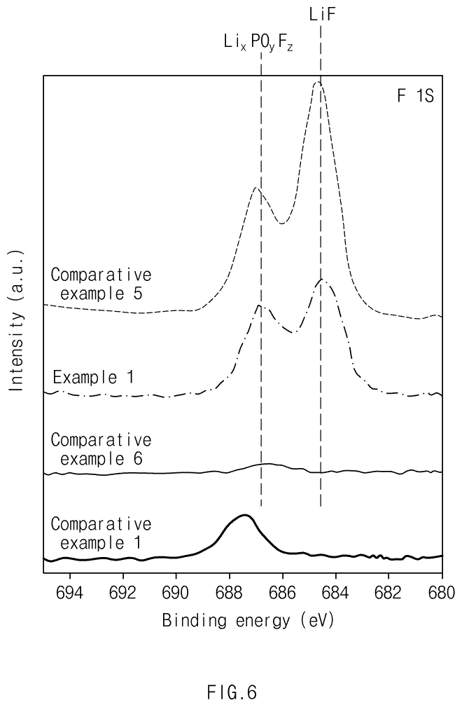

An F1s spectrum was obtained by performing X-ray Photoelectron Spectroscopy (XPS) analysis with respect to each of anodes manufactured according to Examples 1 and 2, and comparative examples 1 to 7, with the data shown in FIGS. 5 and 6. In addition, the intensity of each peak observed in the F1s spectrum is shown in Table 2.

The XPS analysis was performed using NEXSA (by Thermo Scientific; AlKα radiation; an accelerating voltage of 1486.6 eV; a maximum resolution of 0.50 eV).

TABLE 2

| | LiₓPO_{y}F_{z}(I₄) | LiF(I₃) | I₃/I₄ |
|---|---|---|---|
| Example 1 | 11840.15 | 14642.94 | 1.24 |
| Example 2 | 11247.6 | 14769.3 | 1.31 |
| Comparative example 1 | — | — | — |
| Comparative example 2 | 14127.9 | 18769.9 | 1.33 |
| Comparative example 3 | 9694.77 | 13283.6 | 1.37 |
| Comparative example 4 | 15659.38 | 24489.24 | 1.56 |
| Comparative example 5 | 15786 | 29792 | 1.89 |
| Comparative example 7 | 9922.9 | 6063.6 | 0.61 |

Referring to FIGS. 5 and 6, a peak (third peak) observed in a range from 684.0 eV to 686.0 eV is a peak associated with an LiF compound observed in each of the anodes according to Examples 1 and 2 and Comparative Examples 1 to 5 and 7, and a peak (fourth peak) observed in a range from 686.1 eV to 688.0 eV is a peak associated with a LiₓPO_{y}F_{z} compound observed in each of the anodes of Examples 1 and 2 and Comparative Examples 1 to 5 and 7.

Referring to Table 2, the data appears to show that the LiF compound and the LiₓPO_{y}F_{z} compound are not observed for Comparative example 1 in which the pre-lithiation is not performed.

In addition, the data appears to show that the LiF compound is excessively produced, such that the I₃/I₄ value exceeds 1.5, for Comparative examples 4 and 5 in which the pre-lithiation time exceeds 150 minutes,

Further, the data appears to show that the I₃/I₄ value was less than 1.0, as the LiF compound was not sufficiently formed, in the pre-lithiation reaction based on Electrochemical lithiation.

### Experimental Example 4—Color Analysis

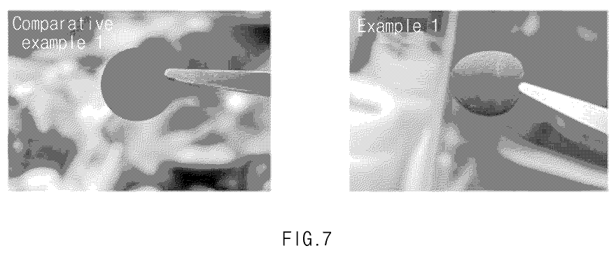

An image obtained by capturing anodes manufactured according to Example 1 and Comparative example 1 is shown in FIG. 7, and RGB color was measured with respect to the captured image through illustrator software.

Referring to FIG. 7, the RGB color according to Comparative example 1 was determined as a dark gray color (R: 93, G: 92, and B: 97) through measurement. The RGB color according to Example 1 was determined as a dark yellow color (R: 121, G: 119, and B: 96). The color according to Example 1 was more yellowish than the color according to Comparative example 1, which may be attributable to the presence of the generated compounds, that is, the compounds of LiC₆, Li₁₅Si₄, or LiₓPO_{y}F_{z} and an LiF compound formed through the pre-lithiation reaction.

### Experimental Example 5—CS-SEM Analysis

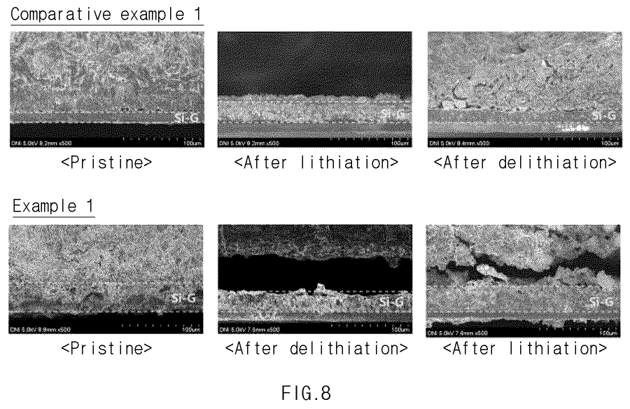

The cross-section is captured through a CS-SEM, with respect to each of half-cells according to Example 1 and Comparative example 1, which were manufactured in Experimental example 4, i) in the initial stage, ii) when the operating voltage ranging from 0.01 V to 1.5 V and the current density of 100 mA/mg are applied to the half-cells under the conditions of the driving pressure 65 MPa and the temperature of 60° C., and iii) in the discharged state, and the captured images are shown in FIG. 8.

Referring to FIG. 8, the data appears to show that the thickness changed from 35.0 μm to 25.0 μm and then to 32.3 μm, during the processes of pristine, delithiation, and lithiation, respectively, for Example 1 in which the pre-lithiation process was performed. In addition, the observed thickness changed from 17.4 μm to 26.1 μm and then to 17.8 μm, during the processes of pristine, lithiation, and delithiation, respectively, for Comparative example 1 in which the pre-lithiation process was not performed. Accordingly, the data appears to show that the anode for the lithium secondary battery according to Example 1 had a smaller thickness change as compared to the anode for the lithium secondary battery according to Comparative example 1, which can thereby improve the lifespan characteristics, as the driving pressure loss was suppressed even when the battery was driven for long time periods.

### Experimental Example 6—Battery Characteristic Analysis

For anodes for the lithium secondary battery according to Examples 1 and 2, and Comparative examples 1 to 6, 150 to 200 mg of sulfide solid electrolyte (Li₆PS₅Cl_{0.5}Br_{0.5}) powders were filled, and the result was pressed under the pressure of 500 MPa to place the solid electrolyte layer. Then, a lithium metal foil (by Honjo chemical corp.) having the thickness of 150 μm and punched with the diameter of 11 Φ was inserted into an opposite surface of the solid electrolyte layer. Then, a T-shaped member serving as a lid was inserted into an annular mold and sealed in an up and down direction. Thereafter, a half-cell was manufactured by fastening the annular mold under a fastening pressure of 3 Nm torque using a pressure jig.

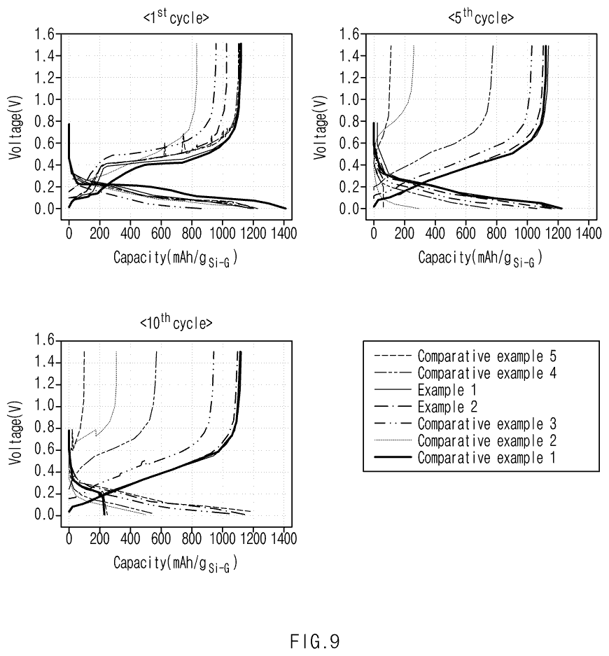

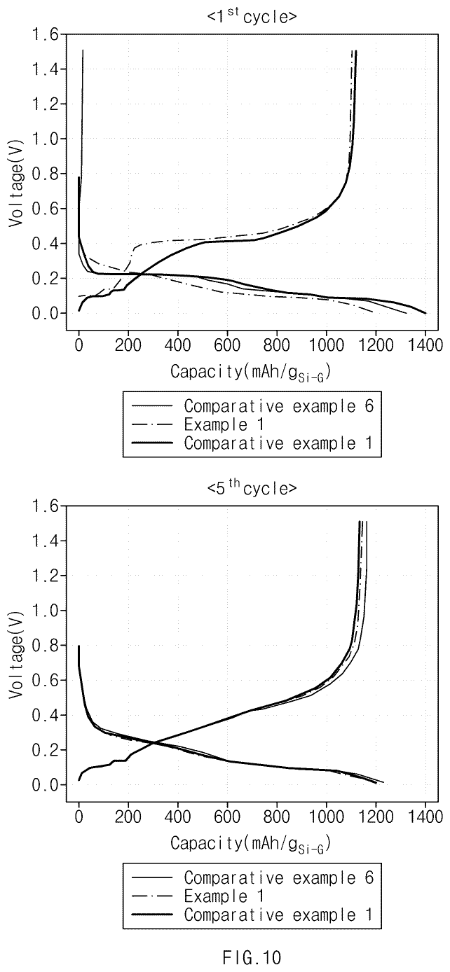

When an operating voltage ranging from 0.01 V to 1.5 V and a current density of 100 mA/mg were applied under the condition of the driving pressure of 65 MPa and the temperature of 60° C. and a discharging operation was performed in one cycle with respect to each of half-cells according to Examples 1 and 2 and Comparative examples 1 to 6, charging/discharging graphs at the first cycle, the fifth cycle, and the tenth-cycle are shown in FIGS. 9 and 10. The initial charging capacity and the initial efficiency measured at the first cycle according to Examples 1 and 2 and Comparative examples 1 to 5 are shown in Table 3.

TABLE 3

| | Initial | |
|---|---|---|
| | charging | Initial |
| | Capacity | efficiency |
| | (mAh/g) | (%) |
| Example 1 | 1028.3 | 87.3 |
| Example 2 | 1105.5 | 93.1 |
| Comparative example 1 | 1118.2 | 79.6 |
| Comparative example 2 | 828.9 | 70.7 |
| Comparative example 3 | 955.1 | 111.6 |
| Comparative example 4 | 1105.1 | 90.6 |
| Comparative example 5 | 1115.5 | 948.2 |
| Comparative example 6 | 16.5 | 1.25 |

Referring to Table 3, it may be recognized that an excellent initial charging capacity and an excellent initial efficiency were exhibited in Examples 1 and 2. In addition, it may be recognized that Comparative example 1 without pre-lithiation and Comparative example 2 having a lower pre-lithiation time were degraded in initial efficiency, as compared to the Examples in accordance with the disclosure. In addition, it may be recognized that the initial charging capacity was remarkably degraded for Comparative example 6 in which the pre-lithiation process was performed without an electrolyte.

Referring to FIGS. 9 and 10, the half-cells according to Examples 1 and 2 were stably driven without the reduction of lifespan at a 10-th cycle, and half-cells according to Comparative examples 2 and 3 were not stably driven due to an internal short circuit at 10-th cycle.

The data appears to show that lifespan was reduced due to the LiF compound formed in excess in the pre-lithiation process, as the cycle progresses, with respect to the half-cell according to Comparative example 4. The data also appears to show that the half-cell according to Comparative example 5 was not driven at all cycles.

As described above, the anode for the lithium secondary battery may be manufactured in accordance with the aspects and embodiments described herein, and can exhibit excellent initial capacity and excellent initial efficiency while stably driving even over periods of long time. Such anodes can be achieved through the various materials and methods for manufacturing the anode for the lithium secondary battery according to the various examples and embodiments of the present disclosure.

Although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An anode for a lithium secondary battery, the anode comprising:
a current collector;
an anode active material layer disposed on the current collector; and
a surface layer disposed on the anode active material layer,
wherein by X-ray diffraction (XRD) analysis the anode comprises a characteristic ratio, (I₂/I₁), of a peak intensity (I₂) of a second peak, observed at a position having 2θ of 23.5±0.2°, to a peak intensity (I₁) of a first peak, observed at a position having 2θ of 24±0.2°, is at least 0.21, and
wherein by X-ray Photoelectron Spectroscopy (XPS) analysis the anode comprises a second characteristic ratio, (I₄/I₃), of a peak intensity (I₄) of a fourth peak, observed in a section ranging from 684.0 eV to 685.5 eV, to a peak intensity (I₃) of a third peak, observed in a section ranging from 686.0 eV to 688.0 eV, is 1.5 or less.

2. The anode of claim 1, wherein the I₁ value ranges from 4,000 a.u. to 6,000 a.u.

3. The anode of claim 1, wherein the I₂ value ranges from 1,000 a.u. to 1,500 a.u.

4. The anode of claim 1, wherein the I₃ value ranges from 10,000 a.u. to 13,000 a.u.

5. The anode of claim 1, wherein the I₄ value ranges from 14,000 a.u. to 19,000 a.u.

6. The anode of claim 1, wherein the anode for the lithium secondary battery comprises a red color value (R) ranging from 115 to 125, a green color value (G) ranging from 115 to 125, and a blue color value (B) ranging from 90 to 100, when viewed with reference to an RGB color chart.

7. The anode of claim 1, wherein the surface layer has a thickness ranging from 10 nm to 100 nm.

8. The anode of claim 1, wherein the (XRD) does not have an observable peak at a position of 23.5±0.2°.

9. The anode of claim 1, wherein the anode active material layer comprises at least one carbon-based compound and at least one silicon-based compound.

10. The anode of claim 9, wherein the at least one carbon-based compound comprises graphite, mesocarbon microbeads (MCMB), highly oriented graphite (HOPG), amorphous carbon, hard carbon, and/or soft carbon, and the at least one silicon-based compound comprises a general formula of SiOₓ where 0≤x<2.

11. The anode of claim 9, wherein the carbon-based compound comprises a lithiated LiC₆ phase, and the silicon-based compound comprises a lithiated Li₁₅Si₄ phase.

12. The anode of claim 1, wherein the surface layer disposed on the anode active material layer comprises (i) a lithium fluoride-based compound of the general Formula LiₓF_{y}, and (ii) a lithium fluoride phosphate-based compound of the general formula LiₓPO_{y}F_{z}, wherein x, y, and z are each independently positive numbers.

13. The anode of claim 1, wherein the surface layer disposed on the anode active material layer comprises (i) a lithium fluoride-based compound of the general Formula LiₓF_{y}, and (ii) a lithium fluoride phosphate-based compound of the general formula LiₓPO_{y}F_{z}, wherein x, y, and z are each independently positive numbers.

14. A lithium secondary battery including the anode according to claim 1.

15. A method for manufacturing an anode for a lithium secondary battery, the method comprising:
forming an anode active material layer comprising a carbon-based compound and a silicon-based compound, on a current collector (S1);
applying an electrolyte solution comprising a fluoride-based lithium salt to a surface of the anode active material layer (S2); and
bringing lithium metal into contact with the surface of the anode active material layer having the electrolyte solution for a time ranging from 75 minutes to 150 minutes (S3).

16. The method of claim 15, wherein the contact in S3 is performed under a pressure condition ranging from 0.2 kg/cm² to 1 kg/cm².

17. The method of claim 15, wherein the contact in S3 is performed for a time ranging from 90 minutes to 120 minutes.

18. The method of claim 15, further comprising:
removing the lithium metal and the electrolyte solution after the contact time is complete.

19. The method of claim 15, wherein the fluoride-based lithium salt in the electrolyte solution comprises LiPF₆ in a concentration ranging from 0.1 M to 2.0 M.

20. An anode for a lithium secondary battery manufactured according to the method of claim 15.
